(19) United States
(12) Patent Application Publication
(10) Pub. No.: US 2016/0249263 A1
(43) Pub. Date: Aug. 25, 2016

(54) DECISION-MAKING PROCESS FOR A COMMUNICATION HANDOVER IN AN IN-BAND INTERFERENTIAL CONTEXT

(71) Applicant: Commissariat a l'energie atomique et aux energies alternatives, Paris (FR)

(72) Inventors: Emilio CALVANESE STRINATI, Grenoble (FR); Matthieu De Mari, Le Mee Sur Seine (FR)

(73) Assignee: Commissariat a l'energie atomique et aux energies alternatives, Paris (FR)

(21) Appl. No.: 15/051,004

(22) Filed: Feb. 23, 2016

(30) Foreign Application Priority Data
Feb. 24, 2015 (FR) 15 51569

(51) Int. Cl. H04W 36/20; H04J 11/00; H04W 72/08

(52) U.S. Cl. CPC H04W 36/20; H04W 72/082; H04J 11/005

(57) ABSTRACT

A method of link adaptation in a telecommunications system including determining a first modulation and coding scheme for a communication of a transmitting terminal with a first receiving terminal, which optimizes a function of interest, for a second receiving terminal, determining a second modulation and coding scheme that optimizes the function of interest when the communication from the transmitting terminal is handed over from the first receiving terminal to the second receiving terminal while being subject to a second interference due to at least one communication that uses the same transmission resources; selecting, from among the first receiving terminal and at least one second receiving terminal, the receiving terminal to optimize the function of interest.

### TECHNICAL FIELD

The invention relates to the field of cellular telecommunications systems. The invention more particularly relates to a decision-making mechanism for a communication handover in an in-band interferential context.

### BACKGROUND OF THE INVENTION

One of the problems affecting communication within a cellular telecommunications system is the interference generated by the other communications of the adjacent cell(s). Traditionally, a distinction is made between intercellular interference due to communications of adjacent cells, and intracellular interference due to communications of the same cell where the terminal is located.

Many techniques have been proposed and implemented to avoid or reduce intracellular interference. Most of these techniques are based on an orthogonal transmission resource allocation, for example time division multiple access (TDMA), frequency division multiple access (FDMA), subcarrier intervals of an orthogonal frequency-division multiple access (OFDMA), transmission codes multiple access (CDMA), space division multiple access (SDMA), or a combination of such resources, so as to separate the different communications of the same cell.

Transmission resources being rare, they are generally reused, at least partially, from one cell to the next. A radio resource management (RRM) module is then responsible for statically or dynamically allocating the transmission resources to the different cells. It is in particular known to reuse transmission frequencies according to a predetermined scheme (Frequency Reuse Pattern).

This management of transmission resources is, however, not very effective in high-density networks, heterogeneous networks or M2M (machine to machine) networks. A heterogeneous network refers to the superposition of a first cellular network having a low spatial granularity with at least one second cellular network with a high spatial granularity (made up of femtocells or picocells). The first cellular network is then called macrocellular, as opposed to the second network.

The allocation of orthogonal resources in the aforementioned networks would indeed result in insufficient use of these resources and a low spectral efficiency. As a result, communications relative to users belonging to adjacent cells, or cells with different hierarchical levels in a heterogeneous network, generally experience an in-band interference.

For a given communication, here called first communication, in-band interference commonly refers to the interference caused by a second communication using the same transmission resource as the first. By opposition, inter-band interference is that caused by a second communication using a separate transmission resource (for example, an adjacent transmission frequency or another transmission interval) from that used by the first.

A network in which in-band interference is predominant relative to the thermal noise is said to be an “interference limited network” inasmuch as the capacities of the different links of the network are more constrained by the interference than by the noise itself.

The processing and reduction of intra-band interference have been subject to considerable research.

The simplest processing method is to consider the interference to be simple thermal noise. This processing method is, however, only acceptable if the interference level is low. It should be noted that most power allocation algorithms are based on this hypothesis.

Other processing methods make it possible to reduce the interference by decoding the information signal of the interfering communication(s). This assumes that the receiving terminal in question knows the codes that were used to code them. Among these methods, in particular known are interference reduction schemes of the parallel interference canceler (PIC) or successive interference canceler types, well known by those skilled in the art.

Another traditional approach to reduce the interference level is to implement an adaptive power control method. Such a method makes it possible to control the power levels of the various transmitting terminals so as to guarantee a predetermined quality of service to the different users. This quality of service can be measured depending on the case in terms of throughput, latency time, packet error rate, spatial coverage, etc. The parameter(s) used to measure it are conventionally referred to as quality of service metrics. In general, a communication from a user requires a minimum quality of service that is taken into account or negotiated during the procedure for admitting the user into the cell. This minimum quality of service is expressed in the form of a constraint on the quality of service metrics: latency below a threshold, throughput above a guaranteed minimum, etc. The power allocation is then done so as to respect the constraint on the quality of service metrics.

Patent applications FR-A-2,963,194 and FR-A-2,963,195 proposed a power allocation method, centralized or distributed, under a quality of service constraint. More specifically, for a given quality of service constraint, this power allocation method makes it possible to reduce the transmission powers of the terminals taking into account certain interference regimes affecting the different communications. Thus, according to this method, if one considers a first communication between a first transmitting terminal and a first receiving terminal, interfered with by a second communication between a second transmitting terminal and a second receiving terminal, three possible interference regimes are distinguished for the first communication: a strong SINR (signal to noise and interference ratio) regime, in which the first receiver processes the signal of the second communication as thermal noise; a second moderate SINR regime, in which the first receiver jointly decodes the information signals of the first and second communications; and lastly, a third low SINR regime, in which the first receiver first decodes the information signal of the second communication, and subtracts its contribution from the received signal before decoding the information signal of the second communication from the signal thus obtained.

This power allocation method works well for a pair of interfering communications. However, for a larger number of interfering communications, the situation becomes substantially more complex. It will in fact be understood that a power allocation to a given transmitter influences the interference diagram of the other communications and can modify their respective interference regimes. Thus, the power modification of a transmitter can lead to a power modification of one or more other transmitters. The power allocation can become unstable and diverge until resulting in a situation where all of the transmitters in question are transmitting at maximum power.

The aim of the present invention is to propose a link optimization method in a wireless telecommunications network, without power allocation modification of the various transmitters and therefore without significant disruption of the interference situation between the different communications.

### BRIEF DESCRIPTION OF THE INVENTION

The invention in this respect proposes a method for link adaptation in a wireless telecommunications system comprising a transmitting terminal, a first receiving terminal and at least one second receiving terminal, a communication from the transmitting terminal with the first receiving terminal being subject to a first interference due to at least one communication with the at least one second receiving terminal which uses the same transmission resources, the method comprising:
determining a first modulation and coding scheme for the communication of the transmitting terminal with the first receiving terminal, which optimizes a function of interest,
for each second receiving terminal, determining a second modulation and coding scheme that optimizes the function of interest in the hypothesis where the communication from the transmitting terminal is handed over from the first receiving terminal to the second receiving terminal while being subjected to a second interference due to at least one communication that uses said same transmission resources;
to ensure the communication with the transmitting terminal, selecting, from among the first receiving terminal and the at least one second receiving terminal, the receiving terminal making it possible to best optimize the function of interest.

Certain preferred, but non-limiting aspects of the method are as follows:
it further comprises, when the first receiving terminal is selected to ensure the communication of the transmitting terminal, a step of processing the first interference using a processing type associated with an interference regime corresponding to the first modulation and coding scheme;
it further comprises, when a second receiving terminal is selected to ensure the communication of the transmitting terminal, a step of handing over the communication of the first transmitting terminal from the first receiving terminal toward the selected second receiving terminal, followed by a step of processing the second interference according to a processing type associated with an interference regime corresponding to the second modulation and coding scheme;
the step of handing over the communication of the first transmitting terminal from the selected first receiving terminal toward the second receiving terminal is only done if the difference between the optimized function of interest obtained with the second receiving terminal and the optimized function of interest obtained with the first receiving terminal is above a threshold;
the function of interest depends on the throughputs of the communication of the transmitting terminal with the first receiving terminal and the at least one communication with the at least one second receiving terminal;
the determination of the modulation and coding scheme for the communication of the transmitting terminal with the first receiving terminal, respectively for the communication of the transmitting terminal handed over to the second receiving terminal, is done in a centralized manner by a control node;
the determination of the modulation and coding scheme for the communication of the transmitting terminal with the first receiving terminal, respectively for the communication of the transmitting terminal handed over to the second receiving terminal, is done by the first receiving terminal, respectively by the second receiving terminal, and the latter transmits the scheme thus determined to the second, respectively first, transmitting terminal.

### BRIEF DESCRIPTION OF THE DRAWINGS

Other aspects, aims, advantages and features of the invention will better appear upon reading the following detailed description of preferred embodiments thereof, provided as a non-limiting example, and done in reference to the appended drawings, in which:

FIG. 1 is a diagram of an in-band interference model in a cellular communication system;

FIG. 2 shows an interference diagram for a communication;

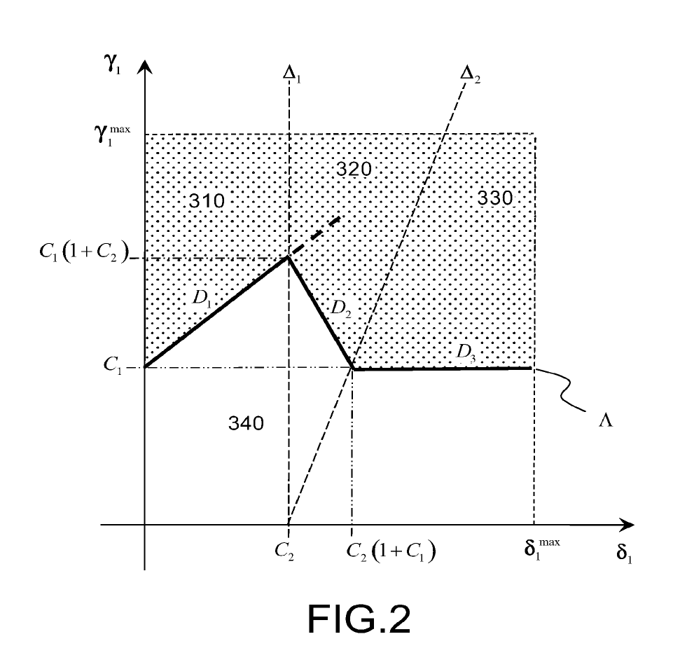

FIG. 3 is a flowchart of a method according to one possible embodiment of the invention.

### DETAILED DESCRIPTION OF THE INVENTION

Here, we consider a wireless communication system comprising a plurality of pairs of transmitting terminals and receiving terminals and we assume that a communication between the terminals of one pair may interfere with the communication between the terminals of another pair, for example because these two communications use shared transmission resources (in-band interference).

The wireless communication system can for example be a cellular communication network, an ad hoc communication network, a heterogeneous network comprising a macrocellular level and a femtocellular level.

In a heterogeneous network, the considered communications can be at two different levels, for example one at the macrocellular level and the other at the femtocellular level.

Each of the communications can either be uplink or downlink, the transmitting terminal or receiving terminal expression being considered in its broad meaning, and in particular including a base station or an access point of the network.

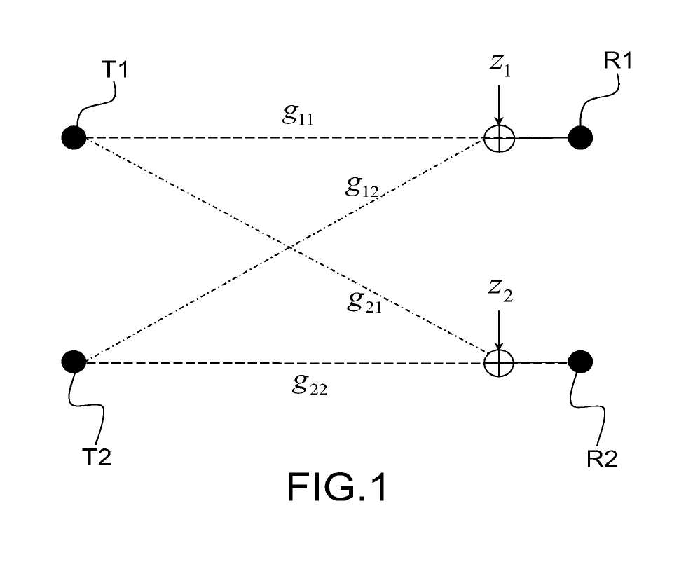

For simplification of the presentation, we first place ourselves in the case of a system only having two pairs of terminals, as illustrated in FIG. 1.

If x₁, x₂ are the signals respectively transmitted by the transmitting terminals T1 and T2, and y₁, y₂ denote the signals respectively received by the receiving terminals R1 and R2, we have:

y₁=g₁₁x₁+g₁₂x₂+z1

y₂=g₂₂x₂+g₂₁x1+z2 (1)

where z₁, z₂ are Gaussian white noise samples, g₁₁, g₂₁ are channel coefficients between the transmitting terminal T1 and the receiving terminals R1 and R2, respectively, and g₂₂, g₁₂ are the channel coefficients between the transmitting terminal T2 and the receiving terminals R2 and R1, respectively.

It will be understood that the interference between communications is shown in (1) by the cross terms g₁₂x₂ and g₂₁x1.

For the first communication, between the first transmitter T1 and receiver R1, the respective powers of the information signal and the interference due to the second communication are respectively |g₁₁|²P1 and |g₁₂|²P2.

Similarly, for the second communication, between the second transmitter and receiver, the respective powers of the information signal and the interference due to the first communication are respectively |g₂₂|²P2 and |g₂₁|²P1.

The signal-to-noise ratio (SNR) at the first receiver can be expressed in the form:

$${γ}_{1} = {\vert {ℊ}_{11} \vert}^{2} \frac{P 1}{N 0} \qquad ( 2 )$$

Similarly, the interference to noise ratio at the first receiving terminal is none other than:

$${δ}_{1} = {\vert {ℊ}_{12} \vert}^{2} \frac{P 2}{N 0} \qquad ( 3 )$$

Likewise, the signal-to-noise and interference-to-noise ratios at the second receiving terminal can respectively be written as:

$$\begin{matrix}{γ}_{2} = {\vert {ℊ}_{22} \vert}^{2} \frac{P 2}{N 0} & ( 4 ) \\ and & \\ {δ}_{2} = {\vert {ℊ}_{21} \vert}^{2} \frac{P 1}{N 0} & ( 5 )\end{matrix}$$

The following relationships are verified:

$$\begin{matrix}{δ}_{1} = {f}_{2} {γ}_{2} and {δ}_{2} = {f}_{1} {γ}_{1} & ( 6 ) \\ Where & \\ {f}_{1} = \frac{{\vert {ℊ}_{21} \vert}^{2}}{{\vert {ℊ}_{11} \vert}^{2}} and {f}_{2} = \frac{{\vert {ℊ}_{12} \vert}^{2}}{{\vert {ℊ}_{22} \vert}^{2}} & ( {6}^{′} )\end{matrix}$$

Hereinafter, ρ₁ and ρ₂ denote the respective throughputs on the first and second communication, and the variables C₁=2^{ρ}^{₁}−1, C₂=2^{ρ}^{₂}−1 and C₁₂=2^{ρ+P}−1 are introduced.

The throughputs ρ₁ and ρ₂ can also be expressed as ρ₁=v₁B and ρ₂=v₂B, where v₁ and v₂ are respectively the spectral efficiency for the first communication and the spectral efficiency for the second communication, expressed in bits/s/Hz, and where B is the bandwidth of the shared transmission resources.

The target spectral efficiency for a link depends on the Modulation and Coding Scheme (MCS) used on that link. In general, the spectral efficiency is proportional to the coding rate and to the modulation order that are chosen for transmission on the link in question.

It is known that for a signal to noise and interference ratio (SINR) on a link, it is possible to obtain a good quality of service (QoS), for example in terms of binary error rate (BER) or packet error rate (PER), using an MCS scheme with a low spectral efficiency and therefore low coding rate, or a lower quality of service using an MCS scheme with a high spectral efficiency and therefore a higher throughput. In general, the choice of the MCS scheme is a compromise between spectral efficiency and robustness of the link.

For a pair of given throughputs (ρ₁, ρ₂), it is possible to distinguish several interference regimes, each regime leading to a different processing. More specifically, it is in particular possible to classify the interference in three possible regimes.

Broadly speaking, in a first regime, the power of the interference due to the second communication is lower than the power of the information signal received at the first receiving terminal. More specifically, if we reason in terms of capacity within the meaning of Shannon, the signal to noise and interference ratio on the direct channel between the transmitting terminal T1 and the receiving terminal R1 makes it possible to pass the throughput ρ₁, while the signal-to-noise ratio on the “cross” channel between the transmitting terminal T2 and the receiving terminal R1 does not make it possible to pass the throughput ρ₂ (the “cross” channel is in a cutoff situation within the meaning of information theory), in other words:

$$\begin{matrix}{ρ}_{1} \leq {log}_{2} ( 1 + {SNR}_{11} ) = {log}_{2} ( 1 + \frac{{γ}_{1}}{1 + {δ}_{1}} ) & ( 7 ) \\ and & \\ {ρ}_{2} > {log}_{2} ( 1 + {INR}_{12} ) = {log}_{2} ( 1 + {δ}_{1} ) & ( 8 )\end{matrix}$$

where SNR₁₁ and INR₁₂ are respectively the signal-to-noise plus interference ratio and the interference to noise ratio at the first receiving terminal R1.

In this regime, the information signal of the second communication cannot be decoded due to the cutoff of the cross channel. It is then considered to be thermal noise for the decoding of the information signal of the first communication.

The following constraints are deduced from this on the first regime:

y₁≧C₁(1+δ₁) (9)

and

δ₂<C₂ (10)

Conversely, in a third regime, the interference power is substantially greater than that of the information signal received by the first receiving terminal. Given that the interference is due to the second communication, it is proposed to first decode the information signal of the second communication, estimate the interference due to this communication and subtract it from the received signal. The information signal of the first communication is next decoded from the resulting signal, rid of the interference.

In this regime, in a first step, the signal of the first communication is considered to be thermal noise and the information signal of the second communication is decoded. One is therefore in a symmetrical situation with respect to that of the first regime, and expression (7) should be replaced with:

$${ρ}_{2} \leq {log}_{2} ( 1 + {SNR}_{12} ) = {log}_{2} ( 1 + \frac{{δ}_{1}}{1 + {γ}_{1}} ) \qquad ( 11 )$$

where SNR₁₂ is the “signal-to-noise” ratio at the receiving terminal R1 in which the signal is heard as the information signal of the second communication.

In a second step, once the contribution of the second communication is subtracted from the received signal, one is back in the case of a signal simply noised by thermal noise, in other words:

ρ₁≦log₂(1+SNR₁₁)=log₂(1+γ₁) (12)

where SNR₁₁ is the signal-to-noise ratio after elimination of the interference due to the second communication.

Expressions (11) and (12) are reflected by the following constraints on γ₁ and δ₁:

$$\begin{matrix}{γ}_{1} \leq \frac{{δ}_{1}}{{C}_{2}} - 1 & ( 13 ) \\ and & \\ {γ}_{1} \geq {C}_{1} & ( 14 )\end{matrix}$$

Lastly, in a second regime, the power of the interference is of the same order as that of the information signal. It is then proposed to jointly decode the information signal of the first communication and the information signal of the second communication at the first receiving terminal. The joint decoding of the two information signals may, for example, be done using a PIC scheme or a maximum likelihood decoding method of the MMSE-GDFE (Minimum Mean Square Error—Generalized Decision Feedback Equalizer) type, in a manner known in itself.

This interference regime is midway between the first and third inasmuch as the throughput ρ₂ no longer verifies (8) and (11), in other words:

$${log}_{2} ( 1 + \frac{{δ}_{1}}{1 + {γ}_{1}} ) < {ρ}_{2} \leq {log}_{2} ( 1 + {δ}_{1} ) \qquad ( 15 )$$

However, the joint decoding assumes that the throughputs of the first and second communications can be conveyed by the channel made up of the direct channel and the cross channel, i.e.:

ρ₁+ρ₂≦log₂(1+γ₁+δ₁) (16)

From (15) and (16), one deduces the constraints on γ₁ and δ₁ relative to the second regime:

C₂≦δ₁≦C₂(1+γ₁) (17)

and

γ₁≧C₁₂−δ₁ (18)

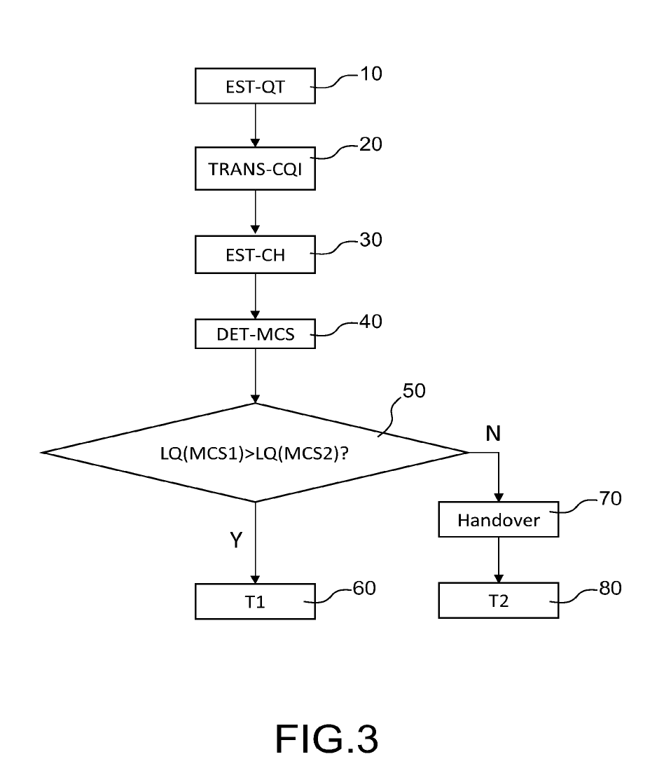

FIG. 3 is an interference diagram in which we have shown the interference-to-noise ratio δ₁ on the x-axis, and the signal-to-noise ratio γ₁ on the y-axis. This diagram is obtained for given throughput values ρ₁ and ρ₂, and consequently for given values of C₁, C₂ and C₁₂.

The ratio γ₁ varies from 0 to γ₁^{max}=|g₁₁|²P₁^{max}/N0 and the ratio δ₁ varies from 0 to δ₁^{max}=|g₁₂|²P₂^{max}/N0, where P₁^{max} and P₂^{max} are the maximum transmission powers of the terminals T1 and T2, respectively.

The lines Δ₁ and Δ₂ defined by the equations

$${δ}_{1} = {C}_{2 } ( cf . ( 10 ) ) and$$

$${γ}_{1} = \frac{{δ}_{1}}{{C}_{2}} - 1 ( cf . ( 13 ) )$$

define the three interference regimes.

The lines D₁, D₂, D₃, respectively defined by the equations γ₁=C₁(1+δ₁) (cf. (⁹)); γ₁=C₁₂−δ₁ (cf. (18)); γ₁=C₁ (cf. (14)), yield the lower power border, denoted A, for each of these regimes.

The zone 310 corresponding to the first interference regime is defined by the lines D1 and Δ₁as well as the y-axis, that 320 corresponding to the second interference regime is defined by the lines Δ₁ and D2, and that 330 corresponding to the third interference regime is lastly defined by the lines Δ₂ and D3.

Below the lower border A is a fourth zone 340, in which it is not possible to process the interference for the requested quality of service, here for the throughputs ρ₁ and ρ₂.

If the throughput of the first or second communication varies, for example due to the selected modulation and coding scheme MCS, the parameters of the equations for the lines D₁, D₂, D₃, Δ₁ and Δ₂ vary. For given throughputs ρ₁, ρ₂, it is possible to determine, from an estimate at the receiver, the power of the information signal, the power of the interference signal and that of the thermal noise, the interference regime in which one currently finds oneself, and to perform the processing related to that zone.

In the preceding, an interference classification is described with three regimes. However, the invention is not limited to such a number of regimes, but on the contrary extends to any number of regimes, in particular a classification using five regimes as for example described in the article by R. H. Etkin et al. titled “Gaussian interference channel capacity to within one bit,” IEEE Trans. Info. Theory, vol. 54, no. 12, pp. 5534-5562, December 2008, or a classification with two regimes not considering the central regimes 320 with joint decoding of the signal and interference as for example used in the method covered by patent application EP 2,763,340 A1.

In the preceding, we have also described the case of two pairs of terminals and an in-band interference situation of the communication of the first pair due to the communication of the second pair. This case is generalized by any number K of pairs of terminals, and therefore a corresponding number K of communications. The interference diagram of FIG. 3 for the communication between the transmitting terminal and the transmitting terminal of the first pair is then built considering the signal-to-noise ratio of this communication and the interference-to-noise ratio resulting from K-1 interfering communications (or the interference-to-noise ratios resulting from each of the K-1 preceding communications).

Considering the first pair of terminals, one can seek to identify an operating point of the receiving terminal that optimizes a function of interest, for example representative of the quality of the link perceived by the receiver, this operating point corresponding to a zone of the interference diagram and therefore to a type of interference processing. Optimization of the function of interest refers to the identification of an operating point making it possible to achieve a quantitative objective. This for example involves an operating point making it possible to achieve an extremum of the function of interest (the optimization then being of the maximization or minimization type). Such a function of interest is called “objective function” in the field of mathematical optimization, where it is used as a criterion to determine the best solution to an optimization problem. Concretely, it associates a value with an instance of an optimization problem. The aim of the optimization problem is then to minimize or maximize this function to the optimum.

The parameters influencing the operation of the receiving terminal are the following:
P_{signal}: the power of the information signal;
Pᵢₙₜₑᵣ: the power of the interference;
tx_{mode}: this parameter groups together all of the parameters of the modulation and coding scheme used in the context of an adaptive modulation/coding (AMC), such as coding rate and the type of modulation;
channel: this parameter groups together all of the events that affect the transmission links and that are not already considered by the preceding parameters; this includes fading, masking, loss of path, the gain of the antenna, etc. The considered channel comprises both the channel carrying the wanted signal and the channels carrying the interfering signals.

Thus, the function of interest LQ can be expressed according to:

LQ=f(P_{signal}, Pᵢₙₜₑᵣ, tx_{mode}, channel), or LQ=f(SNR, INRs, tx_{mode}),

where SNR represents the signal-to-noise ratio of the communication between the terminals of the first pair and where INRs represents the interference-to-noise ratios resulting from the K-1 interfering communications.

We have seen that a change in power allocation disrupts the interference situation between the different communications, and therefore the overall balance of the system. Thus, in the context of the invention, one does not seek to modify the given transmission powers (the powers P_{data} and Pᵢₙₜₑᵣ inter are thus frozen), but to modify the parameter tx_{mode} in order to identify an operating point of the receiver that optimizes the function of interest LQ. In other words, the global interference context (which is reflected by the SNR and INRs ratios) is not modified, but the modulation and coding scheme is adapted locally without this affecting the other communications. One seeks to optimize the function of interest for a set of given SNR, INRs ratios.

As examples of function of interest LQ, we can use a function of interest representative of a spectral efficiency and that depends jointly on the throughputs of the different communications using the same transmission resources (throughputs ρ₁, ρ₂ in the case of two pairs of terminals). For example, it is possible to seek to maximize the sum of the throughputs (Sum Rate Maximization), or to guarantee a minimum throughput or throughputs proportional to the link quality. It is also possible to use a function of interest representative of an energy efficiency and that depends jointly on the consumption of the different communications (one then seeks to reduce the energy cost). The function of interest can also be a metric representative of the electromagnetic field produced by one and/or the other of the terminals, when one for example seeks to minimize the radiation level to which the user of the transmitting terminal is for example exposed. Another example of function of interest is a function representative of the latency (for example, the waiting time for packet transmission) when one seeks to minimize the service time frame. And of course, the function of interest can be a combination of several metrics, when one is seeking to perform a multi-criteria optimization.

Returning to FIG. 1, the invention relates to a link adaptation method for a wireless telecommunications system comprising a transmitting terminal T1, a first receiving terminal R1 and at least one second receiving terminal R2. A communication of the transmitting terminal T1 with the first receiving terminal R1 is subject to a first interference due to at least one communication that uses the same transmission resources (in-band interference). In the example of FIG. 1, the interfering communication corresponds to the communication between the second transmitting terminal T2 and the second receiving terminal R2. In general, however, the invention extends to the case of several interfering communications using the same transmission resources as the communication between the transmitting terminal T1 and the first receiving terminal R1.

The method comprises a step for determining a first modulation and coding scheme MCS₁ for the communication of the transmitting terminal T1 with the first receiving terminal (R1) that optimizes the function of interest LQ.

The first modulation and coding scheme MCS₁ thus determined makes it possible to identify a first interference regime in an interference diagram for the first receiving terminal R1 ensuring the communication with the transmitting terminal T1 and subject to the first interference, and therefore a type of processing of the first interference.

The method also includes, for each second receiving terminal R2, a step for determining a second modulation and coding scheme MCS₂ that optimizes the function of interest in the hypothesis where the communication from the transmitting terminal T1 is handed over from the first receiving terminal R1 to the second receiving terminal R2 while being subject to a second interference due to at least one communication that uses said same transmission resources. In other words, a virtual handover is done of the communication of the transmitting terminal T1 from the first receiving terminal R1 to the second receiving terminal R2 in order to assess how the function of interest could be optimized if this handover was actually done.

In the case of two pairs of terminals illustrated by FIG. 1, the second interference corresponds to a communication with the first receiving terminal that uses said same transmission resources.

In the case where one considers two or more second receiving terminals, the second interference corresponds to a communication with the first receiving terminal that uses said same transmission resources and one or more communications with one or more other second receiving terminals that use said same transmission resources.

The second modulation and coding scheme MCS₂ thus determined makes it possible to identify a second interference regime in an interference diagram for the second receiving terminal R2 ensuring the communication with the transmitting terminal T1 and subject to the second interference, and therefore a type of processing of the second interference.

Then, the method comprises a step for selecting, among the first receiving terminal R1 and the at least one second receiving terminal R2, the receiving terminal R1 or R2 making it possible to obtain the function of interest that is most optimized to ensure communication with the transmitting terminal T1. One thus adopts the first or second determined modulation and coding scheme, depending on whether the first or second receiving terminal is selected.

One thus targets the most appropriate interference regime, i.e., that which optimizes the function of interest for a given set of SNR, INRs ratios. This regime corresponds to the first regime (related to the first modulation and coding scheme) or the second regime (related to the second modulation and coding scheme) depending on whether the first terminal R1 or the second terminal R2 is selected to ensure the communication with the transmitting terminal T1.

Thus, when the first receiving terminal is selected to ensure the communication of the transmitting terminal, a processing step of the first interference is carried out according to a processing type associated with the first interference regime corresponding to the first modulation and coding scheme MCS₁.

When a second receiving terminal is selected to ensure the communication of the transmitting terminal, a step of handing over the communication of the first transmitting terminal from the first receiving terminal to the selected second receiving terminal is carried out, followed by a step of processing the second interference according to a processing type associated with the second interference regime corresponding to the second modulation and coding scheme MCS₂.

In one possible embodiment, the step of handing over the communication of the first transmitting terminal from the first receiving terminal to the selected second receiving terminal is only done if the deviation between the optimization of the function of interest obtained with the second receiving terminal and the optimization of the function of interest obtained with the first receiving terminal is above a threshold. This threshold seeks to ensure that the performance gain related to the performance of the handover is great enough, for example to cover the cost of the handover or to respect energy efficiency constraints.

In another possible embodiment, the interference regime corresponding to the selected modulation and coding scheme cannot be accepted. As an example, one may seek to avoid the central regime of the three-regime classification, the associated processing of which indeed proves relatively complex and therefore consumes a large quantity of computing resources. One possible criterion to decide whether to accept working in a given interference regime may consist of verifying whether an operating point of the receiving terminal in question (for example, the charge level of its battery, or the quantity of computing resources already used for other activities) or a third-party piece of equipment (for example, equipment on which the computing load can be fully or partially discharged) exceeds a threshold. If the interference regime corresponding to the selected modulation and coding scheme is not accepted, an adjacent regime is selected.

In the context of this embodiment, before processing the interference according to the processing type associated with an interference regime corresponding to the selected modulation and coding scheme, the method includes a step for modifying the interference diagram for the first communication consisting of modifying the borders between the zones 310, 320, 330 corresponding to the different regimes, for example in order to decrease the surface area of the zone 320 corresponding to the central regime. The amplitude of the modification may depend on the value of the operating point of the receiving terminal or the third-party equipment. As an example, the surface area of the central zone 320 can be all the more limited as the charge level of the battery of the terminal becomes lower. Of course, this step is carried out for the interference diagram of the communication with the first receiving terminal in the absence of handover of the communication, and for the interference diagram of the communication with the second receiving terminal in case of handover of the communication.

One will understand from the preceding that the invention proposes a mechanism for deciding whether to hand over a communication from a first receiving terminal to a second receiving terminal that makes it possible to limit the unwanted effects of the interference affecting the communications between access points and user terminals (both uplink and downlink), without requiring power allocation modifications.

Assuming that the interference pattern perceived by a user terminal (transmitting terminal T1) is known, i.e., all of the interference-to-noise ratios INRs due to the interfering communications are known, the invention proposes to exploit the diversity of access points (the first receiving terminal R1 and the at least one second receiving terminal R2) to which the user terminal T1 can be assigned.

Each receiving terminal R1, R2 offers a different signal-to-noise ratio SNR, since it depends on the power allocated to the terminal and the channel between the terminal and the transmitting terminal. The invention assigns the transmitting terminal T1 to the receiving terminal R1, R2 that makes it possible to optimize the function of interest LQ. If the optimal receiving terminal differs from that to which the transmitting terminal T1 is assigned by default (the first receiving terminal R1), a handover of the communication can be done.

The invention is based on the following hypotheses:
the old and new access points use the same transmission resources;
the old access point still uses the same transmission resources after the handover, since it was responsible for in-band interference in the adjacent cells before the handover and it must still be the cause of the same in-band interference after the handover in order not to affect the global interference context;
the new access point is selected from among a list of access points that use these same transmission resources before the handover, since otherwise, it would be a source of new in-band interference that would affect the global interference context.

We have seen above that the method according to the invention can be generalized to K pairs of terminals. Since this number can be high, one can opt for a suboptimal, but easier-to-implement solution consisting of considering the interference of a set of pairs to be thermal noise. The interference of a second transmitting terminal is thus treated as a source of noise.

For example, for a given pair, it is possible to consider that all of the communications of all of the other pairs, with the exception of one or more pairs (for example, those that are closest, those causing the highest interference level or those making it possible to best optimize the function of interest), are weakly interfering and one decides to process them as thermal noise. These other communications therefore do not influence the decision whether to hand over the communication, and the type of processing of the interference.

On the contrary, one can consider that in addition to the interference considered in the classification that has its own characteristics that one uses to process and eliminate it, the interference of a set of pairs corresponds not to thermal noise, but to interference that therefore comes into consideration in the process of deciding whether to hand over the communication to an interfering terminal.

FIG. 3 diagrammatically shows a method for adapting a link according to one possible embodiment of the invention. In this embodiment, the link adaptation is done in a centralized manner in a control node, which can be a node of the network (user terminal, base station, ad hoc node).

In the first step “EST-QT” 10, for each link between the transmitting terminal and a receiving terminal, the receiving terminal estimates the quality of said link. Different metrics can be used to that end. For example, the link quality can be estimated in terms of signal to noise and interference ratio (SINR) or using an effective exponential SINR metric, called exp-ESM, more adapted to non-ergodic channels, or using a metric based on instantaneous mutual information or on logarithmic likelihood ratios (LLR) at the output of a flexible output decoder. The SINR or exp-ESM ratio can be measured in a manner known in itself using a pilot sequence transmitted by the transmitting terminal on said link.

This estimate can be a short-term estimate (for example, based on the coherence time of the channel), a long-term estimate (for example, by averaging the information relative to the interference over a given time horizon), or a statistical estimate (for example, using a priori knowledge of the interference, where mapping of the interference experienced in a region can for example be used as a match table).

In the following step “TRANS-CQI” 20, each receiving terminal sends to the control node an indicator of the quality of the link estimated in the preceding step. This channel quality indicator (COI) is generally obtained using a match table associating each SINR level (in dB) with a CQI index with a given pitch (of approximately 2 dB). Each CQI index is further associated with a MCS scheme (and therefore a given spectral efficiency). The higher the CQI index is, the better the link is and therefore the higher the modulation order of the MCS scheme can be (resulting in a higher spectral efficiency). The CQI index can be transmitted with a predetermined frequency to take the evolution of the quality of the links over time into account.

During a step “EST-CH” 30, each receiving terminal performs a channel estimate to estimate the coefficients of the direct channel and the cross channel. More specifically, when a first communication is interfered with by a second communication, the first receiver determines the channel coefficients g₁₁ and g₁₂ and the second receiver determines the channel coefficients g₂₂ and g₂₁. These channel coefficients are sent to the control node.

In the step “DET-MCS” 40, the control node has the set of CQI indices of the different links, in other words, a mapping of the quality of the links of the system. The control node then determines the modulation and coding schemes MCS₁, MCS₂ that optimize the function of interest respectively for the communication of the transmitting terminal with the first receiving terminal subject to the first interference, and the communication of the transmitting terminal virtually handed over from the first receiving terminal to the second receiving terminal and subject to the second interference.

In step 50, it is verified whether the function of interest would be more optimal if the first modulation scheme MCS₁ was adopted rather than if one handed the communication over to the second receiving terminal and adopted the second modulation scheme MCS₂.

If yes (“Y”), a step “T1” 60 is carried out to implement the first modulation and coding scheme MCS₁ and process the first interference depending on the type of processing associated with the interference regime corresponding to this first modulation and coding scheme MCS₁.

If no (“N”), a “Handover” step 70 is done for handing over the communication to the second receiving terminal, then a step “T2” 80 for implementing the second modulation and coding scheme MCS₂ and processing the second interference depending on the type of processing associated with the interference regime corresponding to this second modulation and coding scheme MCS₂.

In another embodiment, the link adaptation is not done in a centralized manner, but on the contrary, in a decentralized manner by one of the terminals, which thus makes the decision whether to perform the handover of the communication to the second receiving terminal. To that end, this terminal receives the CQI indicators and the channel coefficients from the first and second receiving terminals.

For example, the determination of the modulation and coding scheme for the communication of the transmitting terminal with the first receiving terminal, for the communication of the transmitting terminal handed over to the second receiving terminal, respectively, is done by the first receiving terminal, by the second receiving terminal, respectively, and the latter sends the scheme thus determined the second, first transmitting terminal, respectively.

1. A method for link adaptation in a wireless telecommunications system comprising a transmitting terminal, a first receiving terminal and at least one second receiving terminal, a communication from the transmitting terminal with the first receiving terminal being subject to a first interference due to at least one communication with the at least one second receiving terminal, which uses the same transmission resources, the method comprising the steps of:
determining a first modulation and coding scheme for the communication of the transmitting terminal with the first receiving terminal, which optimizes a function of interest,
for each second receiving terminal, determining a second modulation and coding scheme that optimizes the function of interest in the hypothesis where the communication from the transmitting terminal is handed over from the first receiving terminal to the second receiving terminal while being subject to a second interference due to at least one communication that uses said same transmission resources;
to ensure the communication with the transmitting terminal, selecting, from among the first receiving terminal and the at least one second receiving terminal, the receiving terminal making it possible to best optimize the function of interest, together with adopting, respectively, the first or second determined modulation and cooling scheme.

2. The method according to claim 1, further comprising, when the first receiving terminal is selected to ensure the communication of the transmitting terminal, a step of processing the first interference in accordance with an interference regime corresponding to the first modulation and coding scheme.

3. The method according to claim 2, comprising, before the step of processing the first interference in accordance with an interference regime corresponding to the first modulation and coding scheme, a step of modifying an interference diagram for the communication of the transmitting terminal with the first receiving terminal by modifying borders between different interference regimes.

4. The method according to claim 1, further comprising, when a second receiving terminal is selected to ensure the communication from the transmitting terminal, a step of handing over the communication of the first transmitting terminal from the first receiving terminal to the selected second receiving terminal, followed by a step of processing the second interference in accordance with an interference regime corresponding to the second modulation and coding scheme.

5. The method according to claim 4, wherein the step of handing over the communication of the first transmitting terminal from the selected first receiving terminal to the second receiving terminal is only done if the deviation between the optimized function of interest obtained with the second receiving terminal and the optimized function of interest obtained with the first receiving terminal is above a threshold.

6. The method according to claim 4, comprising, before the step of processing the second interference in accordance with an interference regime corresponding to the second modulation and coding scheme, a step of modifying an interference diagram for the communication of the transmitting terminal handed over to the second receiving terminal by modifying borders between different interference regimes.

7. The method according to claim 1, wherein the interference of a second transmitting terminal is treated as a source of noise.

8. The method according to claim 1, wherein the function of interest depends on the throughputs of the communication of the transmitting terminal with the first receiving terminal and the at least one communication with the at least one second receiving terminal.

9. The method according to claim 1, comprising a step of measuring the quality of the link at the first receiving terminal and the quality of the link at the at least one second receiving terminal using a signal to noise and interference ratio or an effective exponential SINR metric, and a step of deducing a quality index of said link.

10. The method according to claim 1, wherein the determination of the modulation and coding scheme for the communication of the transmitting terminal with the first receiving terminal, respectively for the communication of the transmitting terminal handed over to the second receiving terminal, is done in a centralized manner by a control node.

11. The method according to claim 1, wherein the determination of the modulation and coding scheme for the communication of the transmitting terminal with the first receiving terminal, respectively for the communication of the transmitting terminal handed over to the second receiving terminal, is done by the first receiving terminal, respectively by the second receiving terminal, and the latter transmits the scheme thus determined to the second, respectively first, transmitting terminal.
